(19) United States
(12) Patent Application Publication
(10) Pub. No.: US 2013/0342114 A1
(43) Pub. Date: Dec. 26, 2013

(54) POWER UNIT AND ORGANIC LIGHT EMITTING DISPLAY DEVICE HAVING THE SAME

(71) Applicant: SAMSUNG DISPLAY CO., LTD., Gyeonggi-Do (KR)

(72) Inventors: Seung-Jun Lee, Gyeonggi-Do (KR); Hak-Ki Choi, Gyeonggi-Do (KR); Jang-Doo Lee, Gyeonggi-Do (KR)

(73) Assignee: Samsung Display Co., Ltd., Gyeonggi-Do (KR)

(21) Appl. No.: 13/733,035

(22) Filed: Jan. 2, 2013

(30) Foreign Application Priority Data
Jun. 22, 2012 (KR) 10-2012-0067435

(51) Int. Cl. G09G 3/32

(52) U.S. Cl. CPC G09G 3/3291
USPC 315/169.3

(57) ABSTRACT

A power unit in an organic light emitting display device is disclosed. The power unit includes a first transistor that turns-on or turns-off in response to a first control signal, the first transistor being coupled between a constant high power voltage and a first output node, a second transistor that turns-on or turns-off in response to a second control signal, the second transistor being coupled between a ground voltage and the first output node, a diode of which an anode electrode is coupled to a variable high power voltage, and a third transistor that turns-on or turns-off in response to a third control signal, the third transistor being coupled between a cathode electrode of the diode and the first output node.

### CROSS-REFERENCE TO RELATED APPLICATIONS

This application claims priority under 35 USC §119 to Korean Patent Applications No. 10-2012-0067435, filed on Jun. 22, 2012 in the Korean Intellectual Property Office (KIPO), the contents of which are incorporated herein in its entirety by reference.

### BACKGROUND

1. Field

The disclosed technology generally relates to an organic light emitting display device. More particularly, the technology relates to a power unit that supplies power voltages in an organic light emitting display device employing a simultaneous emission driving method, and an organic light emitting display device having the power unit.

2. Description of the Related Technology

Recently, an organic light emitting display device has become widely used as a flat panel display of electronic devices. A method of driving the organic light emitting display device may be classified into a sequential emission driving method and a simultaneous emission driving method. The sequential emission driving method sequentially performs a scan operation based on a scan signal, and controls pixels to sequentially emit light by line by line. On the other hand, the simultaneous emission driving method sequentially performs a scan operation based on a scan signal, and controls all pixels to simultaneously emit light.

As the size of organic light emitting display devices gets larger, the simultaneous emission driving method is becoming more prevalent. The simultaneous emission driving method changes voltage levels of power voltages ELVDD and ELVSS according to frame-operation. The simultaneous emission driving method sets the voltage level to the high power voltage ELVDD during an emission period to be different from the voltage level of the high power voltage ELVDD during a non-emission period to reduce power consumption. However, when a voltage level of the high power voltage ELVDD is changed between the emission and non-emission periods, an unwanted current such as a ripple current, a peak current, etc may occur.

### SUMMARY OF CERTAIN INVENTIVE ASPECTS

One inventive aspect is a power unit in an organic light emitting display device. The power unit includes a first transistor configured to turn-on or turn-off in response to a first control signal, the first transistor being coupled between a constant high power voltage and a first output node. The power unit also includes a second transistor configured to turn-on or turn-off in response to a second control signal, the second transistor being coupled between a ground voltage and the first output node. The power unit also includes a diode of which an anode electrode is coupled to a variable high power voltage, and a third transistor configured to turn-on or turn-off in response to a third control signal, the third transistor being coupled between a cathode electrode of the diode and the first output node.

Another inventive aspect is an organic light emitting display device employing a simultaneous emission driving method. The device includes a pixel unit having a plurality of pixel circuits, a scan driving unit configured to provide a scan signal to the pixel circuits, a data driving unit configured to provide a data signal to the pixel circuits, and a control signal generating unit configured to provide an emission control signal to the pixel circuits. The device also includes, a power unit configured to selectively supply a constant high power voltage, a variable high power voltage, and a ground voltage to the pixel circuits as a high power voltage, and configured to selectively supply a constant low power voltage and a ground voltage to the pixel circuits as a low power voltage. The device also includes a timing control unit configured to control the scan driving unit, the data driving unit, the control signal generating unit, and the power unit. The power unit maintains a voltage level of the high power voltage when a frame-operation period is changed from an emission period to a non-emission period.

### BRIEF DESCRIPTION OF THE DRAWINGS

Illustrative, non-limiting example embodiments will be more clearly understood from the following detailed description taken in conjunction with the accompanying drawings.

FIG. 1 is a circuit diagram illustrating a high power voltage supplying unit of a power unit according to example embodiments.

FIG. 2 is a timing diagram illustrating an operation of a high power voltage supplying unit of FIG. 1.

FIGS. 3A through 3D are diagrams illustrating an example in which a high power voltage is supplied according to frame-operation periods of an organic light emitting display device employing a simultaneous emission driving method.

FIG. 4 is a circuit diagram illustrating a low power voltage supplying unit of a power unit according to example embodiments.

FIG. 5 is a timing diagram illustrating an operation of a low power voltage supplying unit of FIG. 4.

FIG. 6 is a timing diagram illustrating an example in which an organic light emitting display device operates based on a high power voltage and a low power voltage supplied by a power unit.

FIG. 7 is a circuit diagram illustrating a high power voltage supplying unit of a power unit according to example embodiments.

FIG. 8 is a timing diagram illustrating an operation of a high power voltage supplying unit of FIG. 7.

FIG. 9 is a block diagram illustrating an organic light emitting display device according to example embodiments.

FIG. 10 is a block diagram illustrating an electronic device having an organic light emitting display device of FIG. 9.

### DETAILED DESCRIPTION OF CERTAIN INVENTIVE EMBODIMENTS

Various example embodiments are described more fully hereinafter with reference to the accompanying drawings, in which some example embodiments are shown. Certain inventive concepts may, however, be embodied in many different forms and should not be construed as being limited to the example embodiments set forth herein. Rather, these example embodiments are provided so that this disclosure will be thorough and complete, and will convey the scope of the various concepts to those skilled in the art. In the drawings, the sizes and relative sizes of layers and regions may be exaggerated for clarity. Like numerals generally refer to like elements throughout.

It will be understood that, although the terms first, second, third etc. may be used herein to describe various elements, these elements should not be limited by these terms. These terms are used to distinguish one element from another. Thus, a first element discussed below could be termed a second element. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

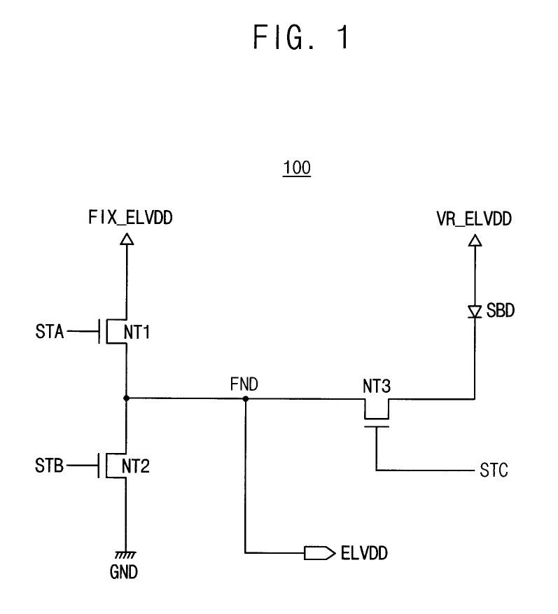

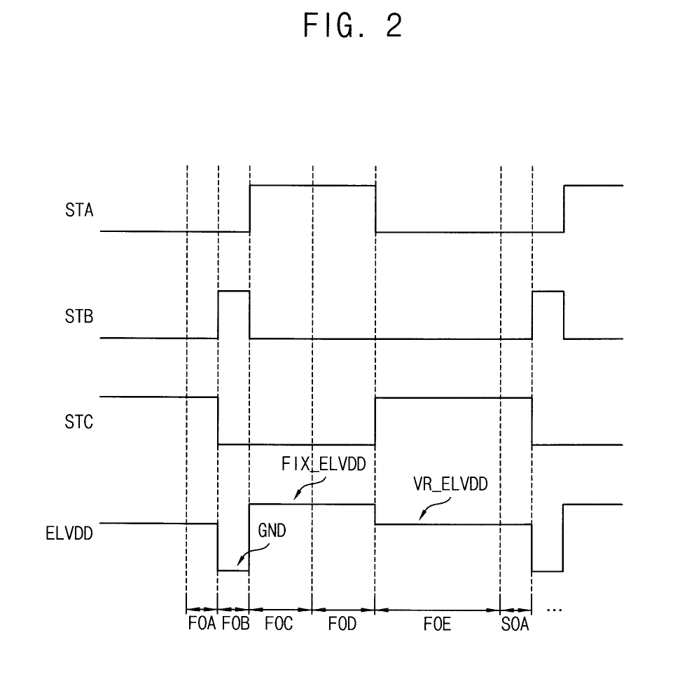

FIG. 1 is a circuit diagram illustrating a high power voltage supplying unit of a power unit according to example embodiments. FIG. 2 is a timing diagram illustrating an operation of a high power voltage supplying unit of FIG. 1.

Referring to FIGS. 1 and 2, the high power voltage supplying unit 100 of the power unit of an organic light emitting display device employing a simultaneous emission driving method is illustrated. The high power voltage supplying unit 100 may include a first transistor NT1, a second transistor NT2, a third transistor NT3, and a diode SBD. The high power voltage supplying unit 100 may selectively output a constant high power voltage FIX_ELVDD, a variable high power voltage VR_ELVDD, and a ground voltage GND as a high power voltage ELVDD through a first output node FND.

The first transistor NT1 may be coupled between the constant high power voltage FIX_ELVDD and the first output node FND. The first transistor NT1 may turn-on or turn-off in response to a first control signal STA. In detail, a first terminal of the first transistor NT1 may be coupled to the constant high power voltage FIX_ELVDD, a second terminal of the first transistor NT1 may be coupled to the first output node FND, and a gate terminal of the first transistor NT1 may receive the first control signal STA. The second transistor NT2 may be coupled between the ground voltage GND and the first output node FND. The second transistor NT2 may turn-on or turn-off in response to a second control signal STB. In detail, a first terminal of the second transistor NT2 may be coupled to the first output node FND, a second terminal of the second transistor NT2 may be coupled to the ground voltage GND, and a gate terminal of the second transistor NT2 may receive the second control signal STB. The third transistor NT3 may be coupled between a cathode electrode of the diode SBD and the first output node FND. The third transistor NT3 may turn-on or turn-off in response to a third control signal STC. In detail, a first terminal of the third transistor NT3 may be coupled to the first output node FND, a second terminal of the third transistor NT3 may be coupled to the cathode electrode of the diode SBD, and a gate terminal of the third transistor NT3 may receive the third control signal STC. As illustrated in FIG. 1, the first through third transistors NT1, NT2, and NT3 may be N-channel metal-oxide semiconductor (NMOS) transistors. Thus, the first through third transistors NT1, NT2, and NT3 may turn-on when the first through third control signals STA, STB, and STC have a logic high level, respectively. On the other hand, the first through third transistors NT1, NT2, and NT3 may turn-off when the first through third control signals STA, STB, and STC have a logic low level, respectively.

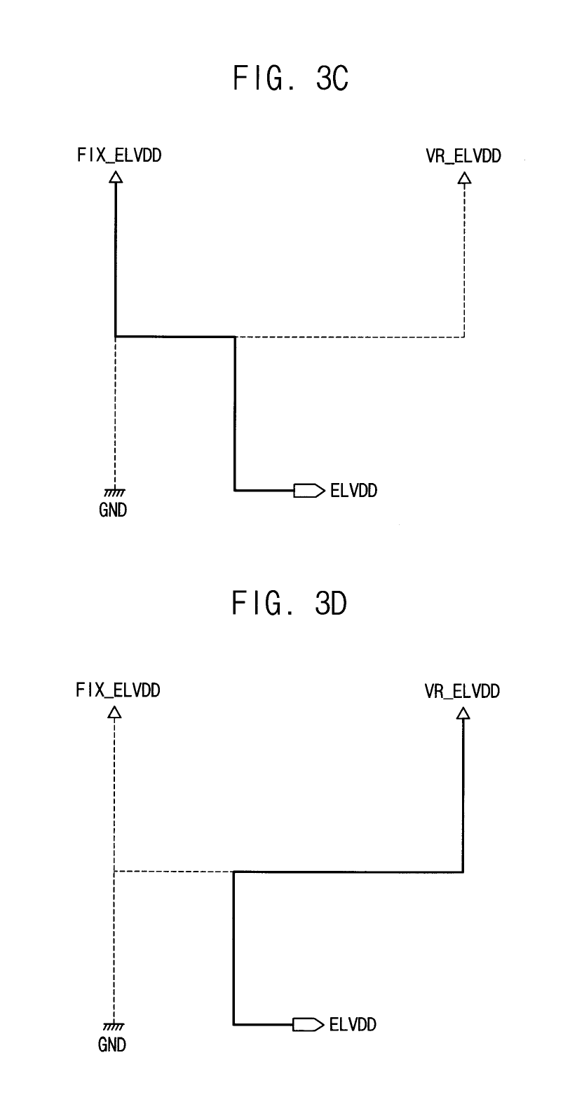

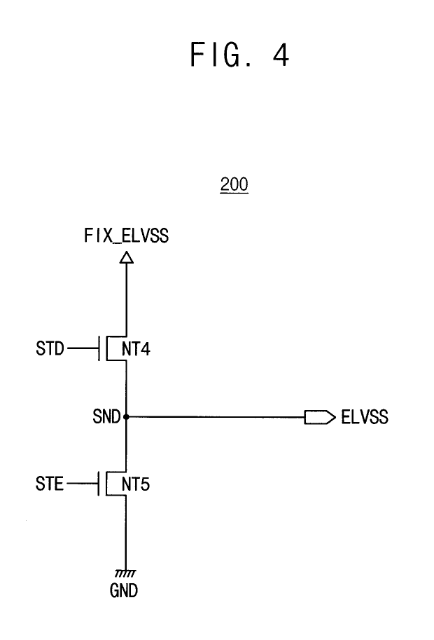

The diode SBD may be coupled between the variable high power voltage VR_ELVDD and the third transistor NT3. In detail, an anode electrode of the diode SBD may be coupled to the variable high power voltage VR_ELVDD, and the cathode electrode of the diode SBD may be coupled to the second terminal of the third transistor NT3. In one example embodiment, the diode SBD may be Schottky Barrier Diode. The Schottky Barrier Diode depends on majority carriers of a semiconductor having forward-current characteristics. Thus, the Schottky Barrier Diode may operate at a high speed because injections and accumulations of minority carriers that limit a switching speed are intrinsically prevented. The high power voltage supplying unit 100 of the power unit may selectively supply the constant high power voltage FIX_ELVDD, the variable high power voltage VR_ELVDD, and the ground voltage GND to pixel circuits as the high power voltage ELVDD by using a simple structure that includes the first transistor NT1, the second transistor NT2, the third transistor NT3, and the diode SBD. In addition, the power unit may further include a low power voltage supplying unit having a simple structure that includes a fourth transistor and a fifth transistor. Here, the low power voltage supplying unit of the power unit may selectively supply a constant low power voltage and a ground voltage as a low power voltage ELVSS. The low power voltage supplying unit of the power unit will be described below with reference to FIGS. 4 and 5.

The frame-operation periods of the organic light emitting display device employing a simultaneous emission driving method may include an initialization period, a reset period, a threshold voltage compensation period, a scan period, and an emission period. Here, the initialization period, the reset period, the threshold voltage compensation period, and the scan period may be referred to as a non-emission period. The simultaneous emission driving method may cyclically change voltage levels of the power voltages ELVDD and ELVSS according to the frame-operation periods (i.e., the initialization period, the reset period, the threshold voltage compensation period, the scan period, and the emission period). In addition, the simultaneous emission driving method may reduce power consumption by controlling a voltage level of the high power voltage ELVDD (e.g., by reducing a voltage level of the high power voltage ELVDD in a dark frame) in the emission period based on a maximum value of a data signal applied in every frame. As a result, when a frame-operation period is changed from the emission period in which the high power voltage ELVDD is the variable high power voltage VR_ELVDD to the non-emission period in which the high power voltage ELVDD is the constant high power voltage FIX_ELVDD, an unwanted current such as a ripple current, a peak current, etc may occur. For example, the ripple current and the peak current may result in image quality degradation and element lifetime shortening. Thus, the high power voltage supplying unit 100 of the power unit may prevent the unwanted current such as the ripple current, the peak current, etc by maintaining a voltage level of the high power voltage ELVDD when a frame-operation period is changed from the emission period to the non-emission period. In detail, the high power voltage supplying unit 100 of the power unit may output the variable high power voltage VR_ELVDD as the high power voltage ELVDD in the emission period, and may also output the variable high power voltage VR_ELVDD as the high power voltage ELVDD in the initialization period. For convenience of descriptions, the initialization period is defined as a period between an end point of an emission period of one frame and a starting point of a reset period of a next frame. Hereinafter, an operation of the high power voltage supplying unit 100 of the power unit will be described in detail with reference to FIG. 2.

In the initialization period FOA of one frame, the first control signal STA may have a logic low level, the second control signal STB may have a logic low level, and the third control signal STC may have a logic high level. Thus, the third transistor NT3 may turn-on in response to the third control signal STC having a logic high level. The first and second transistors NT1 and NT2 may turn-off in response to the first and second control signals STA and STB having a logic low level. As a result, the variable high power voltage VR_ELVDD may be output as the high power voltage ELVDD through the first output node FND. In the reset period FOB of one frame, the first control signal STA may have a logic low level, the second control signal STB may have a logic high level, and the third control signal STC may have a logic low level. Thus, the second transistor NT2 may turn-on in response to the second control signal STB having a logic high level. The first and third transistors NT1 and NT3 may turn-off in response to the first and third control signals STA and STC having a logic low level. As a result, the ground voltage GND may be output as the high power voltage ELVDD through the first output node FND.

In the threshold voltage compensation period FOC of one frame, the first control signal STA may have a logic high level, the second control signal STB may have a logic low level, and the third control signal STC may have a logic low level. Thus, the first transistor NT1 may turn-on in response to the first control signal STA having a logic high level. The second and third transistors NT2 and NT3 may turn-off in response to the second and third control signals STB and STC having a logic low level. As a result, the constant high power voltage FIX_ELVDD may be output as the high power voltage ELVDD through the first output node FND. In the scan period FOD of one frame, the first control signal STA may have a logic high level, the second control signal STB may have a logic low level, and the third control signal STC may have a logic low level. Thus, the first transistor NT1 may turn-on in response to the first control signal STA having a logic high level. The second and third transistors NT2 and NT3 may turn-off in response to the second and third control signals STB and STC having a logic low level. As a result, the constant high power voltage FIX_ELVDD may be output as the high power voltage ELVDD through the first output node FND.

In the emission period FOE of one frame, the first control signal STA may have a logic low level, the second control signal STB may have a logic low level, and the third control signal STC may have a logic high level. Thus, the third transistor NT3 may turn-on in response to the third control signal STC having a logic high level. The first and second transistors NT1 and NT2 may turn-off in response to the first and second control signals STA and STB having a logic low level. As a result, the variable high power voltage VR_ELVDD may be output as the high power voltage ELVDD through the first output node FND. Subsequently, in the initialization period SOA of a next frame, the first control signal STA may have a logic low level, the second control signal STB may have a logic low level, and the third control signal STC may have a logic high level. Thus, the third transistor NT3 may turn-on in response to the third control signal STC having a logic high level. The first and second transistors NT1 and NT2 may turn-off in response to the first and second control signals STA and STB having a logic low level. As a result, the variable high power voltage VR_ELVDD may be output as the high power voltage ELVDD through the first output node FND.

As described above, the high power voltage supplying unit 100 of the power unit may select one of the constant high power voltage FIX_ELVDD, the variable high power voltage VR_ELVDD, and the ground voltage GND as the high power voltage ELVDD according to frame-operation periods (i.e., the initialization period, the reset period, the threshold voltage compensation period, the scan period, and the emission period). Here, the high power voltage supplying unit 100 of the power unit may maintain the high power voltage ELVDD to be the variable high power voltage VR_ELVDD when a frame-operation period is changed from the emission period FOE of one frame to the initialization period SOA of a next frame (i.e., when a frame-operation period is changed from an emission period to a non-emission period). The power unit having the high power voltage supplying unit 100 may prevent an unwanted current such as a ripple current, a peak current, etc by maintaining a voltage level of the high power voltage ELVDD when a frame-operation period is changed from an emission period to a non-emission period in an organic light emitting display device employing a simultaneous emission driving method. As a result, image quality degradation and element lifetime shortening may be prevented. In addition, since the high power voltage supplying unit 100 includes three transistors NT1, NT2, and NT3, the power unit may need only three control signals STA, STB, and STC for controlling the high power voltage supplying unit 100. That is, the power unit is designed (i.e., implemented) by a simple structure, so that the power unit may be suitable for an organic light emitting display device of a large-screen electronic device (e.g., OLED television).

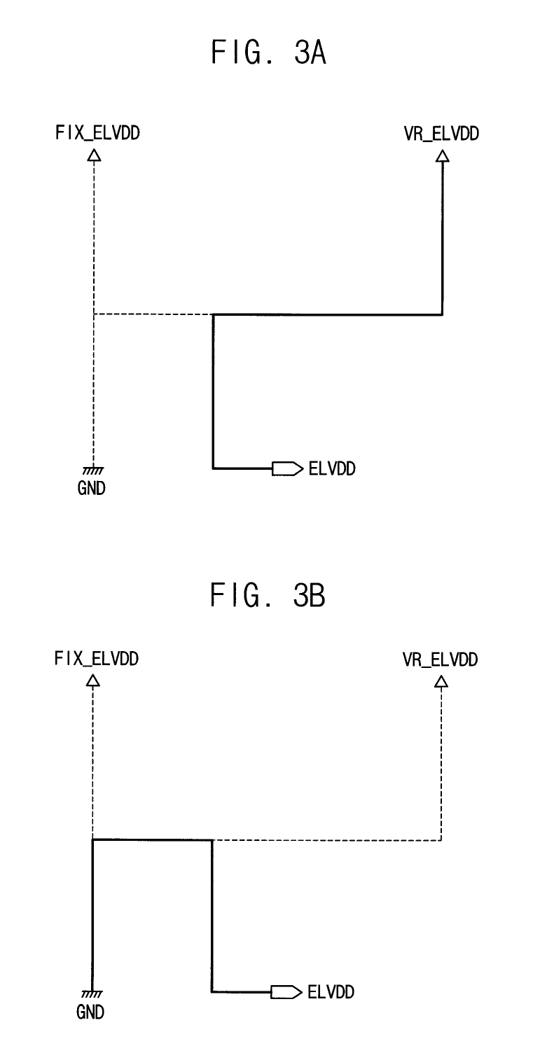

FIGS. 3A through 3D are diagrams illustrating an example in which a high power voltage is supplied according to frame-operation periods of an organic light emitting display device employing a simultaneous emission driving method.

Referring to FIGS. 3A through 3D, it is illustrated that the high power voltage ELVDD is supplied according to the frame-operation periods of the organic light emitting display device. FIG. 3A shows that the variable high power voltage VR_ELVDD is output as the high power voltage ELVDD through the first output node FND in the initialization period FOA of one frame. That is, the third transistor NT3 may turn-on in response to the third control signal STC having a logic high level, and the first and second transistors NT1 and NT2 may turn-off in response to the first and second control signals STA and STB having a logic low level. Hence, the variable high power voltage VR_ELVDD may be output as the high power voltage ELVDD in the initialization period FOA of one frame. FIG. 3B shows that the ground voltage GND is output as the high power voltage ELVDD through the first output node FND in the reset period FOB of one frame. That is, the second transistor NT2 may turn-on in response to the second control signal STB having a logic high level, and the first and third transistors NT1 and NT3 may turn-off in response to the first and third control signals STA and STC having a logic low level. Hence, the ground voltage GND may be output as the high power voltage ELVDD in the reset period FOB of one frame.

FIG. 3C shows that the constant high power voltage FIX_ELVDD is output as the high power voltage ELVDD through the first output node FND in the threshold voltage compensation period FOC of one frame and the scan period FOC of one frame. That is, the first transistor NT1 may turn-on in response to the first control signal STA having a logic high level, and the second and third transistors NT2 and NT3 may turn-off in response to the second and third control signals STB and STC having a logic low level. Hence, the constant high power voltage FIX_ELVDD may be output as the high power voltage ELVDD in the threshold voltage compensation period FOC of one frame and the scan period FOC of one frame. FIG. 3D shows that the variable high power voltage VR_ELVDD is output as the high power voltage ELVDD through the first output node FND in the emission period FOE of one frame. That is, the third transistor NT3 may turn-on in response to the third control signal STC having a logic high level, and the first and second transistors NT1 and NT2 may turn-off in response to the first and second control signals STA and STB having a logic low level. Hence, the variable high power voltage VR_ELVDD may be output as the high power voltage ELVDD in the emission period FOE of one frame.

As described above, the power unit having the high power voltage supplying unit 100 may maintain a voltage level of the high power voltage ELVDD when a frame-operation period is changed from the emission period to the non-emission period in an organic light emitting display device employing a simultaneous emission driving method. As illustrated in FIG. 3A, in the initialization period SOA of a next frame, the variable high power voltage VR_ELVDD may be output as the high power voltage ELVDD through the first output node FND. That is, the third transistor NT3 may turn-on in response to the third control signal STC having a logic high level, and the first and second transistors NT1 and NT2 may turn-off in response to the first and second control signals STA and STB having a logic low level. Hence, the variable high power voltage VR_ELVDD may be output as the high power voltage ELVDD in the initialization period SOA of a next frame. In conclusion, the high power voltage supplying unit 100 of the power unit may prevent an unwanted current such as a ripple current, a peak current, etc by maintaining the high power voltage ELVDD to be the variable high power voltage VR_ELVDD when a frame-operation period is changed from the emission period FOE of one frame to the initialization period SOA of a next frame (i.e., when a frame-operation period is changed from an emission period to a non-emission period). As a result, image quality degradation and element lifetime shortening may be prevented in an organic light emitting display device employing a simultaneous emission driving method.

FIG. 4 is a circuit diagram illustrating a low power voltage supplying unit of a power unit according to example embodiments. FIG. 5 is a timing diagram illustrating an operation of a low power voltage supplying unit of FIG. 4.

Referring to FIGS. 4 and 5, the low power voltage supplying unit 200 of the power unit for an organic light emitting display device employing a simultaneous emission driving method is illustrated. The low power voltage supplying unit 200 may include a fourth transistor NT4 and a fifth transistor NT5. Here, the low power voltage supplying unit 200 may selectively output a constant low power voltage FIX_ELVSS and a ground voltage GND as a low power voltage ELVSS through a second output node SND.

The fourth transistor NT4 may be coupled between the constant low power voltage FIX_ELVSS and the second output node SND. The fourth transistor NT4 may turn-on or turn-off in response to a fourth control signal STD. In detail, a first terminal of the fourth transistor NT4 may be coupled to the constant low power voltage FIX_ELVSS, a second terminal of the fourth transistor NT4 may be coupled to the second output node SND, and a gate terminal of the fourth transistor NT4 may receive the fourth control signal STD.

The fifth transistor NT5 may be coupled between the ground voltage GND and the second output node SND. The fifth transistor NT5 may turn-on or turn-off in response to a fifth control signal STE. In detail, a first terminal of the fifth transistor NT5 may be coupled to the second output node SND, a second terminal of the fifth transistor NT5 may be coupled to the ground voltage GND, and a gate terminal of the fifth transistor NT5 may receive the fifth control signal STE. In one example embodiment, as illustrated in FIG. 4, the fourth and fifth transistors NT4 and NT5 may be NMOS transistors. In this case, the fourth and fifth transistors NT4 and NT5 may turn-on when the fourth and fifth control signals STD and STE have a logic high level, respectively. On the other hand, the fourth and fifth transistors NT4 and NT5 may turn-off when the fourth and fifth control signals STD and STE have a logic low level, respectively. In another example embodiment, the fourth and fifth transistors NT4 and NT5 may be P-channel metal-oxide semiconductor (PMOS) transistors. In this case, the fourth and fifth transistors NT4 and NT5 may turn-on when the fourth and fifth control signals STD and STE have a logic low level, respectively. On the other hand, the fourth and fifth transistors NT4 and NT5 may turn-off when the fourth and fifth control signals STD and STE have a logic high level, respectively.

Generally, frame-operation periods of an organic light emitting display device employing a simultaneous emission driving method may include an initialization period, a reset period, a threshold voltage compensation period, a scan period, and an emission period. Here, the initialization period, the reset period, the threshold voltage compensation period, and the scan period may be referred to as a non-emission period. For convenience of descriptions, the initialization period is defined as a period between an end point of an emission period of one frame and a starting point of a reset period of a next frame. The simultaneous emission driving method may cyclically change voltage levels of the power voltages ELVDD and ELVSS according to the frame-operation periods (i.e., the initialization period, the reset period, the threshold voltage compensation period, the scan period, and the emission period). Therefore, the low power voltage supplying unit 200 of the power unit may select one of the constant low power voltage FIX_ELVSS and the ground voltage GND as the low power voltage ELVSS according to the frame-operation periods (i.e., the initialization period, the reset period, the threshold voltage compensation period, the scan period, and the emission period). Hereinafter, an operation of the low power voltage supplying unit 200 of the power unit will be described in detail with reference to FIG. 5.

As illustrated in FIG. 5, in the non-emission period of one frame (i.e., the initialization period FOA, the reset period FOB, the threshold voltage compensation period FOC, and the scan period FOD of one frame), the fourth control signal STD may have a logic high level, and the fifth control signal STE may have a logic low level. Thus, the fourth transistor NT4 may turn-on in response to the fourth control signal STD having a logic high level, and the fifth transistor NT5 may turn-off in response to the fifth control signal STE having a logic low level. As a result, the constant low power voltage FIX_ELVSS may be output as the low power voltage ELVSS through the second output node FND. On the other hand, in the emission period FOE of one frame, the fourth control signal STD may have a logic low level, and the fifth control signal STE may have a logic high level. Thus, the fifth transistor NT5 may turn-on in response to the fifth control signal STE having a logic high level, and the fourth transistor NT4 may turn-off in response to the fourth control signal STD having a logic low level. As a result, the ground voltage GND may be output as the low power voltage ELVSS through the second output node FND. Subsequently, in the initialization period SOA of a next frame, the fourth control signal STD may have a logic high level, and the fifth control signal STE may have a logic low level. Thus, the fourth transistor NT4 may turn-on in response to the fourth control signal STD having a logic high level, and the fifth transistor NT5 may turn-off in response to the fifth control signal STE having a logic low level. As a result, the constant low power voltage FIX_ELVSS may be output as the low power voltage ELVSS through the second output node SND.

As described above, the low power voltage supplying unit 200 of the power unit may selectively supply the constant low power voltage FIX_ELVSS and the ground voltage GND as the low power voltage ELVSS. In addition, since the low power voltage supplying unit 200 includes two transistors NT4 and NT5, the power unit may need only two control signals STD and STE for controlling the low power voltage supplying unit 200. Further, since the high power voltage supplying unit 100 includes three transistors NT1, NT2, and NT3, the power unit may need only three control signals STA, STB, and STC for controlling the high power voltage supplying unit 100. That is, the power unit is designed (i.e., implemented) by a simple structure, so that the power unit may be suitable for an organic light emitting display device of a large-screen electronic device (e.g., OLED television). Although it is described in FIGS. 1 through 5 that the power unit includes the high power voltage supplying unit 100 and the low power voltage supplying unit 200, it should be understood that the power unit may be separately implemented (e.g., a first power unit including the high power voltage supplying unit 100 and a second power unit including the low power voltage supplying unit 200).

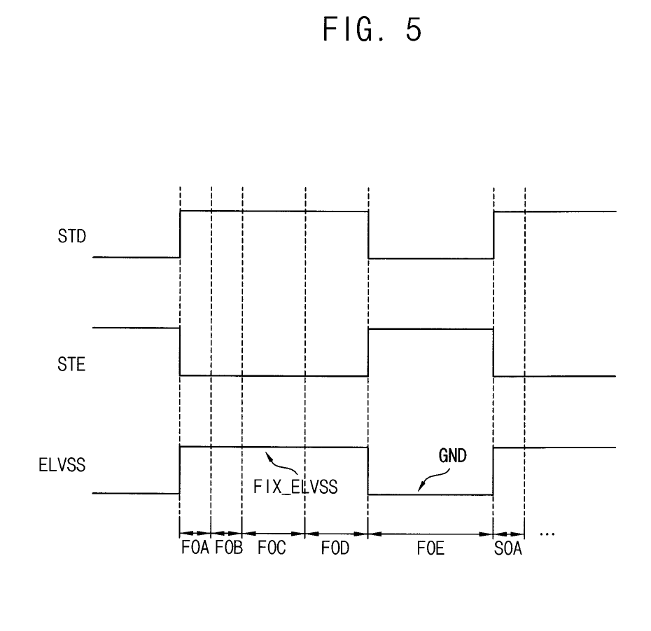

FIG. 6 is a timing diagram illustrating an example in which an organic light emitting display device operates based on a high power voltage and a low power voltage supplied by a power unit. Referring to FIG. 6, the organic light emitting display device may employ a simultaneous emission driving method. In addition, frame-operation periods of the organic light emitting display device may include an initialization period FOA, a reset period FOB, a threshold voltage compensation period FOC, a scan period FOD, and an emission period FOE.

As illustrated in FIG. 6, in the initialization period FOA, the power unit may supply a high power voltage ELVDD corresponding to a variable high power voltage VR_ELVDD, and may a low power voltage ELVSS corresponding to a constant low power voltage FIX_ELVSS. In the initialization period FOA, an initialization operation may be simultaneously performed for all pixel circuits. The initialization period FOA may be defined as a period between an end point of an emission period of one frame and a starting point of a reset period of a next frame. Subsequently, in the reset period FOB, the power unit may supply the high power voltage ELVDD corresponding to a ground voltage GND, and may supply the low power voltage ELVSS corresponding to the constant low power voltage FIX_ELVSS. Since the high power voltage ELVDD has a low voltage level and the low power voltage ELVSS has a high voltage level, a reset operation may be simultaneously performed for all pixel circuits in the reset period FOB. Subsequently, in the threshold voltage compensation period FOC, the power unit may supply the high power voltage ELVDD corresponding to a constant high power voltage FIX_ELVDD, and may supply the low power voltage ELVSS corresponding to the constant low power voltage FIX_ELVSS. Here, a threshold voltage compensation operation may be simultaneously performed for all pixel circuits in the threshold voltage compensation period FOC.

Next, in the scan period FOD, the power unit may supply the high power voltage ELVDD corresponding to the constant high power voltage FIX_ELVDD, and may supply the low power voltage ELVSS corresponding to the constant low power voltage FIX_ELVSS. Here, a scan operation may be sequentially performed for all pixel circuits in the scan period FOD. Subsequently, in the emission period FOE, the power unit may supply the high power voltage ELVDD corresponding to the variable high power voltage VR_ELVDD, and may supply the low power voltage ELVSS corresponding to the ground voltage GND. Since the high power voltage ELVDD has a high voltage level and the low power voltage ELVSS has a low voltage level, an emission operation may be simultaneously performed for all pixel circuits in the emission period FOE. Next, an initialization period SOA of a next frame may begin. Similarly, in the initialization period SOA, the power unit may supply the high power voltage ELVDD corresponding to the variable high power voltage VR_ELVDD, and may supply the low power voltage ELVSS corresponding to the constant low power voltage FIX_ELVSS. Thus, an initialization operation may be simultaneously performed for all pixel circuit in the initialization period SOA.

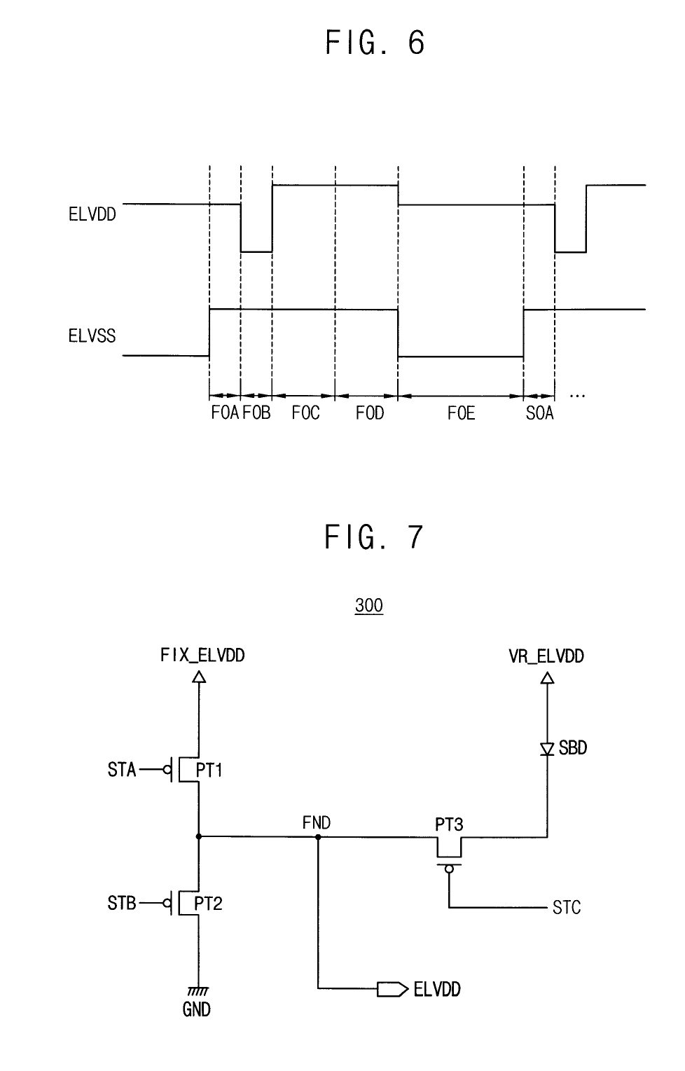

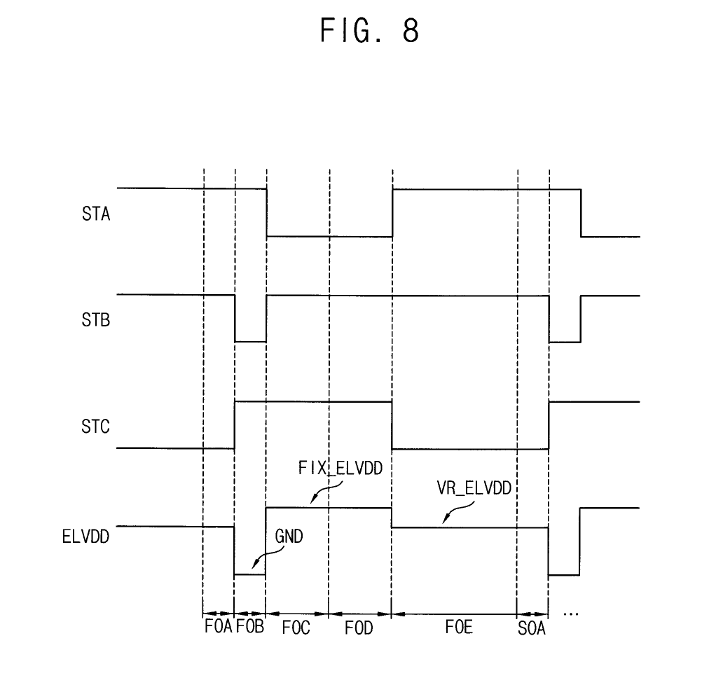

FIG. 7 is a circuit diagram illustrating a high power voltage supplying unit of a power unit according to example embodiments. FIG. 8 is a timing diagram illustrating an operation of a high power voltage supplying unit of FIG. 7.

Referring to FIGS. 7 and 8, the high power voltage supplying unit 300 of the power unit of an organic light emitting display device employing a simultaneous emission driving method is illustrated. The high power voltage supplying unit 300 may include a first transistor PT1, a second transistor PT2, a third transistor PT3, and a diode SBD. The high power voltage supplying unit 300 may selectively output a constant high power voltage FIX_ELVDD, a variable high power voltage VR_ELVDD, and a ground voltage GND as a high power voltage ELVDD through a first output node FND.

The first transistor PT1 may be coupled between the constant high power voltage FIX_ELVDD and the first output node FND. The first transistor PT1 may turn-on or turn-off in response to a first control signal STA. In detail, a first terminal of the first transistor PT1 may be coupled to the constant high power voltage FIX_ELVDD, a second terminal of the first transistor PT1 may be coupled to the first output node FND, and a gate terminal of the first transistor PT1 may receive the first control signal STA. The second transistor PT2 may be coupled between the ground voltage GND and the first output node FND. The second transistor PT2 may turn-on or turn-off in response to a second control signal STB. In detail, a first terminal of the second transistor PT2 may be coupled to the first output node FND, a second terminal of the second transistor PT2 may be coupled to the ground voltage GND, and a gate terminal of the second transistor PT2 may receive the second control signal STB. The third transistor PT3 may be coupled between a cathode electrode of the diode SBD and the first output node FND. The third transistor PT3 may turn-on or turn-off in response to a third control signal STC. In detail, a first terminal of the third transistor PT3 may be coupled to the first output node FND, a second terminal of the third transistor PT3 may be coupled to the cathode electrode of the diode SBD, and a gate terminal of the third transistor PT3 may receive the third control signal STC. As illustrated in FIG. 7, the first through third transistors PT1, PT2, and PT3 may be PMOS transistors. Thus, the first through third transistors PT1, PT2, and PT3 may turn-on when the first through third control signals STA, STB, and STC have a logic low level, respectively. On the other hand, the first through third transistors PT1, PT2, and PT3 may turn-off when the first through third control signals STA, STB, and STC have a logic high level, respectively.

The diode SBD may be coupled between the variable high power voltage VR_ELVDD and the third transistor PT3. In detail, an anode electrode of the diode SBD may be coupled to the variable high power voltage VR_ELVDD, and the cathode electrode of the diode SBD may be coupled to the second terminal of the third transistor PT3. In one example embodiment, the diode SBD may be Schottky Barrier Diode. The Schottky Barrier Diode depends on majority carriers of a semiconductor having forward-current characteristics. Thus, the Schottky Barrier Diode may operate at a high speed because injections and accumulations of minority carriers that limit a switching speed are intrinsically prevented. The high power voltage supplying unit 300 of the power unit may selectively supply the constant high power voltage FIX_ELVDD, the variable high power voltage VR_ELVDD, and the ground voltage GND to pixel circuits as the high power voltage ELVDD by using a simple structure that includes the first transistor PT1, the second transistor PT2, the third transistor PT3, and the diode SBD.

The frame-operation periods of the organic light emitting display device employing a simultaneous emission driving method may include an initialization period, a reset period, a threshold voltage compensation period, a scan period, and an emission period. Here, the initialization period, the reset period, the threshold voltage compensation period, and the scan period may be referred to as a non-emission period. The simultaneous emission driving method may cyclically change voltage levels of the power voltages ELVDD and ELVSS according to the frame-operation periods (i.e., the initialization period, the reset period, the threshold voltage compensation period, the scan period, and the emission period). In addition, the simultaneous emission driving method may reduce power consumption by controlling a voltage level of the high power voltage ELVDD (e.g., by reducing a voltage level of the high power voltage ELVDD in a dark frame) in the emission period based on a maximum value of a data signal applied in every frame. As a result, when a frame-operation period is changed from the emission period in which the high power voltage ELVDD is the variable high power voltage VR_ELVDD to the non-emission period in which the high power voltage ELVDD is the constant high power voltage FIX_ELVDD, an unwanted current such as a ripple current, a peak current, etc may occur. For example, the ripple current and the peak current may result in image quality degradation and element lifetime shortening. Thus, the high power voltage supplying unit 300 of the power unit may prevent the unwanted current such as the ripple current, the peak current, etc by maintaining a voltage level of the high power voltage ELVDD when a frame-operation period is changed from the emission period to the non-emission period. In detail, the high power voltage supplying unit 300 of the power unit may output the variable high power voltage VR_ELVDD as the high power voltage ELVDD in the emission period, and may also output the variable high power voltage VR_ELVDD as the high power voltage ELVDD in the initialization period. For convenience of descriptions, the initialization period is defined as a period between an end point of an emission period of one frame and a starting point of a reset period of a next frame. Hereinafter, an operation of the high power voltage supplying unit 300 of the power unit will be described in detail with reference to FIG. 8.

In the initialization period FOA of one frame, the first control signal STA may have a logic high level, the second control signal STB may have a logic high level, and the third control signal STC may have a logic low level. Thus, the third transistor PT3 may turn-on in response to the third control signal STC having a logic low level. The first and second transistors PT1 and PT2 may turn-off in response to the first and second control signals STA and STB having a logic high level. As a result, the variable high power voltage VR_ELVDD may be output as the high power voltage ELVDD through the first output node FND. In the reset period FOB of one frame, the first control signal STA may have a logic high level, the second control signal STB may have a logic low level, and the third control signal STC may have a logic high level. Thus, the second transistor PT2 may turn-on in response to the second control signal STB having a logic low level. The first and third transistors PT1 and PT3 may turn-off in response to the first and third control signals STA and STC having a logic high level. As a result, the ground voltage GND may be output as the high power voltage ELVDD through the first output node FND.

In the threshold voltage compensation period FOC of one frame, the first control signal STA may have a logic low level, the second control signal STB may have a logic high level, and the third control signal STC may have a logic high level. Thus, the first transistor PT1 may turn-on in response to the first control signal STA having a logic low level. The second and third transistors PT2 and PT3 may turn-off in response to the second and third control signals STB and STC having a logic high level. As a result, the constant high power voltage FIX_ELVDD may be output as the high power voltage ELVDD through the first output node FND. In the scan period FOD of one frame, the first control signal STA may have a logic low level, the second control signal STB may have a logic high level, and the third control signal STC may have a logic high level. Thus, the first transistor PT1 may turn-on in response to the first control signal STA having a logic low level. The second and third transistors PT2 and PT3 may turn-off in response to the second and third control signals STB and STC having a logic high level. As a result, the constant high power voltage FIX_ELVDD may be output as the high power voltage ELVDD through the first output node FND.

In the emission period FOE of one frame, the first control signal STA may have a logic high level, the second control signal STB may have a logic high level, and the third control signal STC may have a logic low level. Thus, the third transistor PT3 may turn-on in response to the third control signal STC having a logic low level. The first and second transistors PT1 and PT2 may turn-off in response to the first and second control signals STA and STB having a logic high level. As a result, the variable high power voltage VR_ELVDD may be output as the high power voltage ELVDD through the first output node FND. Subsequently, in the initialization period SOA of a next frame, the first control signal STA may have a logic high level, the second control signal STB may have a logic high level, and the third control signal STC may have a logic low level. Thus, the third transistor PT3 may turn-on in response to the third control signal STC having a logic low level. The first and second transistors PT1 and PT2 may turn-off in response to the first and second control signals STA and STB having a logic high level. As a result, the variable high power voltage VR_ELVDD may be output as the high power voltage ELVDD through the first output node FND.

As described above, the high power voltage supplying unit 300 of the power unit may select one of the constant high power voltage FIX_ELVDD, the variable high power voltage VR_ELVDD, and the ground voltage GND as the high power voltage ELVDD according to frame-operation periods (i.e., the initialization period, the reset period, the threshold voltage compensation period, the scan period, and the emission period). Here, the high power voltage supplying unit 300 of the power unit may maintain the high power voltage ELVDD to be the variable high power voltage VR_ELVDD when a frame-operation period is changed from the emission period FOE of one frame to the initialization period SOA of a next frame (i.e., when a frame-operation period is changed from an emission period to a non-emission period). The power unit having the high power voltage supplying unit 300 may prevent an unwanted current such as a ripple current, a peak current, etc by maintaining a voltage level of the high power voltage ELVDD when a frame-operation period is changed from an emission period to a non-emission period in an organic light emitting display device employing a simultaneous emission driving method. As a result, image quality degradation and element lifetime shortening may be prevented. In addition, since the high power voltage supplying unit 300 includes three transistors PT1, PT2, and PT3, the power unit may need only three control signals STA, STB, and STC for controlling the high power voltage supplying unit 300. That is, the power unit is designed (i.e., implemented) by a simple structure, so that the power unit may be suitable for an organic light emitting display device of a large-screen electronic device (e.g., OLED television).

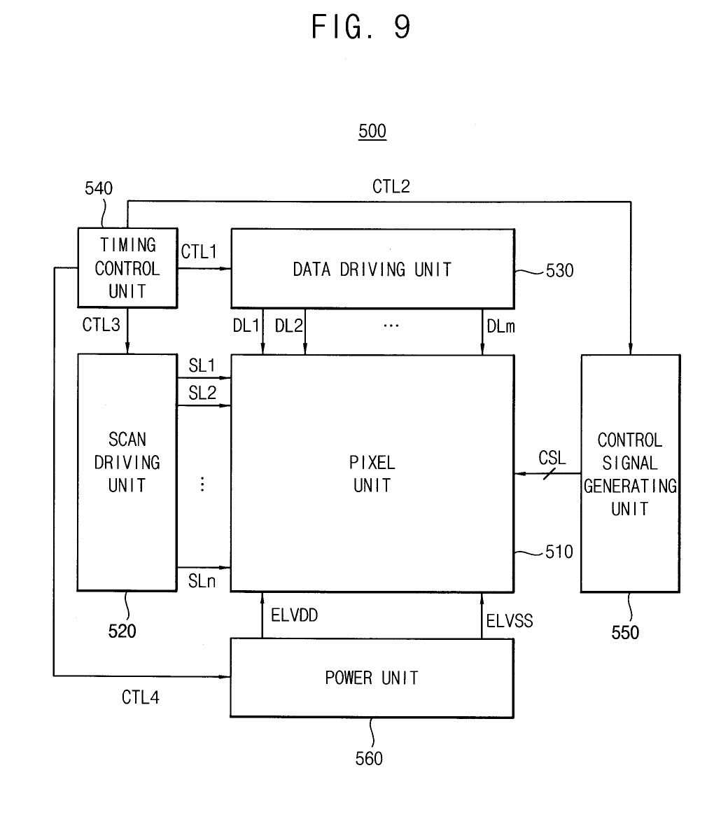

FIG. 9 is a block diagram illustrating an organic light emitting display device according to example embodiments. Referring to FIG. 9, the organic light emitting display device 500 employing a simultaneous emission driving method may include a pixel unit 510, a scan driving unit 520, a data driving unit 530, a timing control unit 540, a control signal generating unit 550, and a power unit 560.

The pixel unit 510 may include a plurality of pixel circuits. The pixel unit 510 may be coupled to the scan driving unit 520 via a plurality of scan-lines SL1 through SLn, may be coupled to the data driving unit 530 via a plurality of data-lines DL1 through DLm, and may be coupled to the control signal generating unit 550 via a plurality of control-lines (not illustrated). Here, since the pixel circuits are located at crossing points of the scan-lines SL1 through SLn and the data-lines DL1 through DLm, the pixel unit 510 may include n*m pixel circuits. The scan driving unit 520 may provide a scan signal to the pixel circuits. The data driving unit 530 may provide a data signal to the pixel circuits. The control signal generating unit 550 may provide an emission control signal CSL to the pixel circuits. The power unit 560 may provide a high power voltage ELVDD and a low power voltage ELVSS to the pixel circuits. The timing control unit 540 may generate a plurality of timing control signals CTL1, CTL2, CLT3, and CTL4 to provide the timing control signals CTL1, CTL2, CLT3, and CTL4 to the scan driving unit 520, the data driving unit 530, the control signal generating unit 550, and the power unit 560. That is, the timing control unit 540 may control the scan driving unit 520, the data driving unit 530, the control signal generating unit 550, and the power unit 560. In conclusion, each of the pixel circuits may operate using the high power voltage ELVDD, the low power voltage ELVSS, the scan signal, the data signal, and the emission control signal CSL based on a simultaneous emission driving method.

When the power unit 560 supplies the high power voltage ELVDD and the low power voltage ELVSS to the pixel circuits, the power unit 560 may select one of a constant high power voltage, a variable high power voltage, and a ground voltage as the high power voltage ELVDD, and may select one of a constant low power voltage and a ground voltage as the low power voltage ELVSS. For this operation, the power unit 560 may include a high power voltage supplying unit and/or a low power voltage supplying unit, such as those described above. In detail, the high power voltage supplying unit may include a first transistor coupled between the constant high power voltage and a first output node, a second transistor coupled between the ground voltage and the first output node, a diode of which an anode electrode is coupled to the variable high power voltage, and a third transistor coupled between a cathode electrode of the diode and the first output node. Here, the first transistor may turn-on or turn-off in response to a first control signal, the second transistor may turn-on or turn-off in response to a second control signal, and the third transistor may turn-on or turn-off in response to a third control signal. In addition, the low power voltage supplying unit may include a fourth transistor coupled between a variable low power voltage and a second output node, and a fifth transistor coupled between a ground voltage and the second output node. Here, the fourth transistor may turn-on or turn-off in response to a fourth control signal, and the fifth transistor may turn-on or turn-off in response to a fifth control signal. In example embodiments, the first through fifth transistors may be NMOS transistors or PMOS transistors. Since the high power voltage supplying unit and the low power voltage supplying unit are described above, duplicated descriptions will be omitted below.

As described above, the power unit 560 having the high power voltage supplying unit may maintain a voltage level of the high power voltage ELVDD when a frame-operation period is changed from an emission period to a non-emission period. In detail, the high power voltage supplying unit of the power unit 560 may output the variable high power voltage as the high power voltage ELVDD in an emission period of one frame, and may also output the variable high power voltage as the high power voltage ELVDD in an initialization period of a next frame. As a result, an unwanted current such as a ripple current, a peak current, etc may be prevented when the power unit 560 supplies the high power voltage ELVDD. Therefore, the organic light emitting display device 500 having the power unit 560 may prevent image quality degradation and element lifetime shortening due to the unwanted current such as the ripple current, the peak current, etc. According to some example embodiments, the scan driving unit 520, the data driving unit 530, the timing control unit 540, the control signal generating unit 550, and the power unit 560 may be implemented by one integrated circuit (IC) chip.

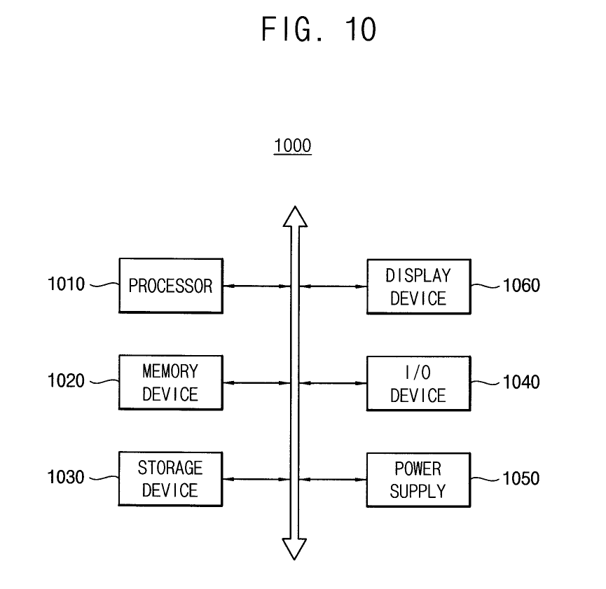

FIG. 10 is a block diagram illustrating an electronic device having an organic light emitting display device of FIG. 9.

Referring to FIG. 10, the electronic device 1000 may include a processor 1010, a memory device 1020, a storage device 1030, an input/output (I/O) device 1040, a power supply 1050, and an organic light emitting display device 1060. Here, the organic light emitting display device 1060 may correspond to the organic light emitting display device 500 of FIG. 9. In addition, the electronic device 1000 may further include a plurality of ports for communicating a video card, a sound card, a memory card, a universal serial bus (USB) device, other electronic devices, etc.

The processor 1010 may perform various computing functions. The processor 1010 may be a micro processor, a central processing unit (CPU), etc. The processor 1010 may be coupled to other components via an address bus, a control bus, a data bus, etc. Further, the processor 1010 may be coupled to an extended bus such as a peripheral component interconnection (PCI) bus. The memory device 1020 may store data for operations of the electronic device 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc, and/or at least one volatile memory device such as a dynamic random access memory (DRAM) device, a static random access memory (SRAM) device, a mobile dynamic random access memory (mobile DRAM) device, etc. The storage device 1030 may be a solid state drive (SSD) device, a hard disk drive (HDD) device, a CD-ROM device, etc.

The I/O device 1040 may be an input device such as a keyboard, a keypad, a mouse, etc, and an output device such as a printer, a speaker, etc. According to some example embodiments, the organic light emitting display device 1060 may be included in the I/O device 1040. The power supply 1050 may provide a power for operations of the electronic device 1000. The organic light emitting display device 1060 may communicate with other components via the buses or other communication links. As described above, the organic light emitting display device 1060 may employ a simultaneous emission driving method. The organic light emitting display device 1060 may include a pixel unit, a scan driving unit, a data driving unit, a timing control unit, a control signal generating unit, and a power unit. Here, the power unit may include a high power voltage supplying unit having a simple structure that includes three transistors and one diode. On this basis, the power unit may maintain a voltage level of a high power voltage when a frame-operation period is changed from an emission period to a non-emission period. Thus, the organic light emitting display device 1060 having the power unit may prevent image quality degradation and element lifetime shortening due to an unwanted current such as a ripple current, a peak current, etc.

The various concepts described herein may be applied to a system having an organic light emitting display device, such as a computer monitor, a laptop, a digital camera, a cellular phone, a smart phone, a smart pad, a television, a personal digital assistant (PDA), a portable multimedia player (PMP), a MP3 player, a navigation system, a game console, a video phone, etc.

The foregoing is illustrative of example embodiments and is not to be construed as limiting thereof. Although a few example embodiments have been described, those skilled in the art will readily appreciate that many modifications are possible in the example embodiments without materially departing from the teachings and advantages of the present inventive concept. Accordingly, all such modifications are intended to be included within the scope of the presently described inventive concepts. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the description.

What is claimed is:

1. A power unit in an organic light emitting display device, the power unit comprising:
a first transistor configured to turn-on or turn-off in response to a first control signal, the first transistor being coupled between a constant high power voltage and a first output node;
a second transistor configured to turn-on or turn-off in response to a second control signal, the second transistor being coupled between a ground voltage and the first output node;
a diode of which an anode electrode is coupled to a variable high power voltage; and
a third transistor configured to turn-on or turn-off in response to a third control signal, the third transistor being coupled between a cathode electrode of the diode and the first output node.

2. The power unit of claim 1, wherein the diode includes a Schottky barrier diode.

3. The power unit of claim 2, wherein the first, second, and third transistors are N-channel metal-oxide semiconductor (NMOS) transistors, wherein the first through third transistors are configured to turn-on when the first, second, and third control signals respectively have a logic high level, and wherein the first, second, and third transistors are configured to turn-off when the first, second, and third control signals respectively have a logic low level.

4. The power unit of claim 2, wherein the first, second, and third transistors are P-channel metal-oxide semiconductor (PMOS) transistors, wherein the first, second, and third transistors are configured to turn-on when the first, second, and third control signals respectively have a logic low level, and wherein the first, second, and third transistors are configured to turn-off when the first, second, and third control signals respectively have a logic high level.

5. The power unit of claim 1, wherein the organic light emitting display device employs a simultaneous emission driving method, and frame-operation periods of the organic light emitting display device include an initialization period, a reset period, a threshold voltage compensation period, a scan period, and an emission period.

6. The power unit of claim 5, wherein the third transistor is configured to turn-on and the first and second transistors are configured to turn-off during the initialization period, and wherein the variable high power voltage is output as a high power voltage through the first output node during the initialization period.

7. The power unit of claim 5, wherein the second transistor is configured to turn-on and the first and third transistors are configured to turn-off during the reset period, and wherein the ground voltage is output as a high power voltage through the first output node during the reset period.

8. The power unit of claim 5, wherein the first transistor is configured to turn-on and the second and third transistors are configured to turn-off during the threshold voltage compensation period, and wherein the constant high power voltage is output as a high power voltage through the first output node during the threshold voltage compensation period.

9. The power unit of claim 5, wherein the first transistor is configured to turn-on and the second and third transistors are configured to turn-off during the scan period, and wherein the constant high power voltage is output as a high power voltage through the first output node during the scan period.

10. The power unit of claim 5, wherein the third transistor is configured to turn-on and the first and second transistors are configured to turn-off during the emission period, and wherein the variable high power voltage is output as a high power voltage through the first output node during the emission period.

11. The power unit of claim 5, further comprising:
a fourth transistor configured to turn-on or turn-off in response to a fourth control signal, the fourth transistor being coupled between a constant low power voltage and a second output node; and
a fifth transistor configured to turn-on or turn-off in response to a fifth control signal, the fifth transistor being coupled between a ground voltage and the second output node.

12. The power unit of claim 11, wherein the fourth and fifth transistors are NMOS transistors, wherein the fourth and fifth transistors are configured to turn-on when the fourth and fifth control signals respectively have a logic high level, and wherein the fourth and fifth transistors are configured to turn-off when the fourth and fifth control signals respectively have a logic low level.

13. The power unit of claim 11, wherein the fourth and fifth transistors are PMOS transistors, wherein the fourth and fifth transistors are configured to turn-on when the fourth and fifth control signals have a logic low level, respectively, and wherein the fourth and fifth transistors are configured to turn-off when the fourth and fifth control signals have a logic high level, respectively.

14. The power unit of claim 11, wherein the fourth transistor is configured to turn-on and the fifth transistor is configured to turn-off during a non-emission period, the non-emission period corresponding to the initialization period, the reset period, the threshold voltage compensation period, and the scan period, and wherein the constant low power voltage is output as a low power voltage through the second output node during the non-emission period.

15. The power unit of claim 11, wherein the fourth transistor is configured to turn-off and the fifth transistor is configured to turn-on during the emission period, and wherein the ground voltage is output as a low power voltage through the second output node during the emission period.

16. An organic light emitting display device employing a simultaneous emission driving method, the device comprising:
a pixel unit having a plurality of pixel circuits;
a scan driving unit configured to provide a scan signal to the pixel circuits;
a data driving unit configured to provide a data signal to the pixel circuits;
a control signal generating unit configured to provide an emission control signal to the pixel circuits;
a power unit configured to selectively supply a constant high power voltage, a variable high power voltage, and a ground voltage to the pixel circuits as a high power voltage, and configured to selectively supply a constant low power voltage and a ground voltage to the pixel circuits as a low power voltage; and
a timing control unit configured to control the scan driving unit, the data driving unit, the control signal generating unit, and the power unit,
wherein the power unit maintains a voltage level of the high power voltage when a frame-operation period is changed from an emission period to a non-emission period.

17. The device of claim 16, wherein the power unit comprises:
a first transistor configured to turn-on or turn-off in response to a first control signal, the first transistor being coupled between the constant high power voltage and a first output node;
a second transistor configured to turn-on or turn-off in response to a second control signal, the second transistor being coupled between the ground voltage and the first output node;
a diode of which an anode electrode is coupled to the variable high power voltage; and
a third transistor configured to turn-on or turn-off in response to a third control signal, the third transistor being coupled between a cathode electrode of the diode and the first output node.

18. The device of claim 17, wherein the power unit further comprises:
a fourth transistor configured to turn-on or turn-off in response to a fourth control signal, the fourth transistor being coupled between the constant low power voltage and a second output node; and
a fifth transistor configured to turn-on or turn-off in response to a fifth control signal, the fifth transistor being coupled between the ground voltage and the second output node.

19. The device of claim 18, wherein the diode comprises a Schottky barrier diode.

20. The device of claim 19, wherein the first through fifth transistors are N-channel metal-oxide semiconductor (NMOS) transistors, wherein the first through fifth transistors are configured to turn-on when the first through fifth control signals respectively have a logic high level, and wherein the first through fifth transistors are configured to turn-off when the first through fifth control signals respectively have a logic low level.

21. The device of claim 19, wherein the first through fifth transistors are P-channel metal-oxide semiconductor (PMOS) transistors, wherein the first through fifth transistors are configured to turn-on when the first through fifth control signals respectively have a logic low level, and wherein the first through fifth transistors are configured to turn-off when the first through fifth control signals respectively have a logic high level.
